(19) United States
(12) Patent Application Publication
(10) Pub. No.: US 2005/0174590 A1
(43) Pub. Date: Aug. 11, 2005

(54) Image correction method, image correction apparatus, and image correction program

(75) Inventor: Masahiro Kubo, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/053,923

(22) Filed: Feb. 10, 2005

(30) Foreign Application Priority Data
Feb. 10, 2004 (JP) 2004-034035

(51) Int. Cl. G06K 15/02; H04N 1/60; G06F 17/00

(52) U.S. Cl. 358/1.9; 358/527; 358/537; 358/538; 715/527; 715/528; 715/856; 715/781

(57) ABSTRACT

A main display section is divided into a plurality of display areas (partial display areas). In each display area, image correction is carried out according to individual correction parameters. A target image for image correction is displayed in an image display area as a single image in a state that each section displayed in each display area has been corrected by using different parameters. In response to moving an indicator, which is displayed on an upper side of the main display section, along a slide bar, a size and a position of each display area is changed. An area size display bar, which shows a display range of each display area, is displayed on the upper side of the main display section. When one display area is selected for inputting the correction parameters, a section of the area size display bar, which corresponds to the selected display area, is highlighted.

### BACKGROUND OF THE INVENTION

1. Field of the Invention

The present invention relates to a method, an apparatus and a program for correcting images while observing images displayed on a monitor provided in an information processing terminal such as a personal computer.

2. Background Arts

Digital image quality can be improved by correcting color balance or tone curve of a digital image by using an information processing terminal, such as a personal computer (PC) . For instance, in a digital camera shooting, image data is transmitted from the digital camera to the PC. An operator can obtain an image with excellent finished quality as intended by adjusting various correction parameters while observing an image displayed on a monitor of the PC. Further, it is also possible to apply image correction by the PC while keeping color information in the digital camera by using a digital camera which is able to output initial image data (RAW data) to the PC without applying white balance correction.

As for an efficient method for image correction, Japanese Patent Laid-Open Publication No. 11-136528 discloses that a plurality of sample images, which correspond to respective correction parameters, are displayed on the monitor, and the correction parameter of the selected sample image is used for the image correction. Thereby, the operator can visually distinguish differences in results of the image correction according to differences in the correction parameters.

In the art disclosed in Japanese Patent Laid-Open Publication No. 11-136528, the sample images on the monitor are displayed away from each other. Therefore, the differences in the results of the image correction are distinguishable if the differences in the correction parameters are significant; however, the differences in the results of the image correction cannot be easily distinguished when the differences in the correction parameters are small, for instance, when making fine adjustments. Especially, in case of studio shooting of a wedding ceremony or product shooting where high image quality is required, precise image correction is necessary. In such cases, the correction parameters are often adjusted in a small range to obtain a desired image. Image correction processing cannot be carried out efficiently when the results of the image correction are difficult to distinguish.

### SUMMARY OF THE INVENTION

In view of the foregoing, it is an object of the present invention to provide an image correction method, an image correction apparatus and an image correction program, which facilitate visual identification of differences in results of image correction caused by differences in correction parameters.

The above and other objects of the present invention are achieved by dividing an image display area on a monitor into a plurality of partial display areas. A part of a target image for image correction, which is displayed in each display area, is corrected according to individual correction parameters.

A shape, a position, and a size of each of the partial display areas can be changed arbitrarily. Further, it is preferable to display an indicator, which shows a boundary of two adjacent partial display areas, in a surrounding area of the image display area, and change the size of each of the partial display areas according to a movement of the indicator.

Further, it is possible to display an area size display bar, which is used for highlighting a selected range of the partial display area for inputting the correction parameter, in the surrounding area of the image display area. Furthermore, it is preferable to display each range of non-selected partial display areas in mutually different color or density in the area size display bar.

It is possible to keep an image display range in each partial display area at a constant proportion while changing a position or a size of the target image, which is to be displayed in the image display area. It is also possible to change the position or the size of the target image displayed in the image display area while keeping a position of the boundary of the partial display areas constant with respect to the target image.

It is possible to display at least one information window which displays values of the correction parameters in rows. Further, it is preferable to use one of the partial display areas as a reference display area which displays a target image corrected by invariable correction parameters. Furthermore, it is preferable that the reference display area is displayed adjacent to all of the remaining partial display areas.

It is possible to generate a composite image by compositing two target images, which are obtained by applying different correction parameters, in a predetermined proportion, and overwrite a part of the partial display area with the composite image. Further, it is possible to display a cursor on the monitor for displaying the composite image, and display the composite image in an area through which the cursor passes. Furthermore, it is possible to increase or decrease the proportion of the composition every time the cursor passes through the area in which the composite image is displayed.

The image correction program of the present invention achieves a function for dividing the image display area on the monitor, which displays the target image for the image correction, into a plurality of the partial display areas, a function for correcting the image according to individual correction parameters with respect to each partial display area, and a function for displaying the target image, which is separately corrected in each partial display area, in the image display area, in a computer.

According to the present invention, a single target image, which is formed of each section corrected by different correction parameters, is displayed by dividing the image display area on the monitor into a plurality of the partial display areas, and partially displaying the target image, which is corrected by the individual correction parameters, in each partial display area. Therefore, the differences in the results of the image correction, which are caused by the differences in the correction parameters, can be visually identified with ease. Therefore, the image correction is carried out efficiently.

### BRIEF DESCRIPTION OF THE DRAWINGS

The above objects and advantages of the present invention will become apparent from the following detailed descriptions of the preferred embodiments when read in association with the accompanying drawings, which are given by way of illustration only and thus do not limit the present invention. In the drawings, the same reference numerals designate like or corresponding parts throughout the several views, and wherein:

FIG. 1 is a block diagram schematically showing configurations of a digital camera and a PC for image correction;

FIG. 2 is an explanatory view showing a first correction screen;

FIG. 3 is an explanatory view showing a second correction screen;

FIG. 4 is an explanatory view showing an example of the second correction screen;

FIG. 5 is an explanatory view showing an example of an information window indicating values of correction parameters;

FIG. 6 is an explanatory view showing an example of the information windows indicating the values of correction parameters;

FIG. 7 is an explanatory view showing an example of changing a display image;

FIG. 8 is an explanatory view showing an example of a zoom display of the display image;

FIG. 9 is an explanatory view showing another example of the zoom display of the display image;

FIG. 10 is an explanatory view showing another example of the second correction screen;

FIG. 11 is an explanatory view showing an image of each display area in a two-dimensional form;

FIG. 12 is an explanatory view showing an example of changing a shape of a reference display area;

FIG. 13 is an explanatory view showing examples of changing a shape of a target image for image correction; and

FIG. 14 is an explanatory view showing an example of an image obtained by compositing two images, which are respectively corrected with two different correction parameters, in a predetermined proportion.

### DETAILED DESCRIPTION OF THE EMBODIMENTS

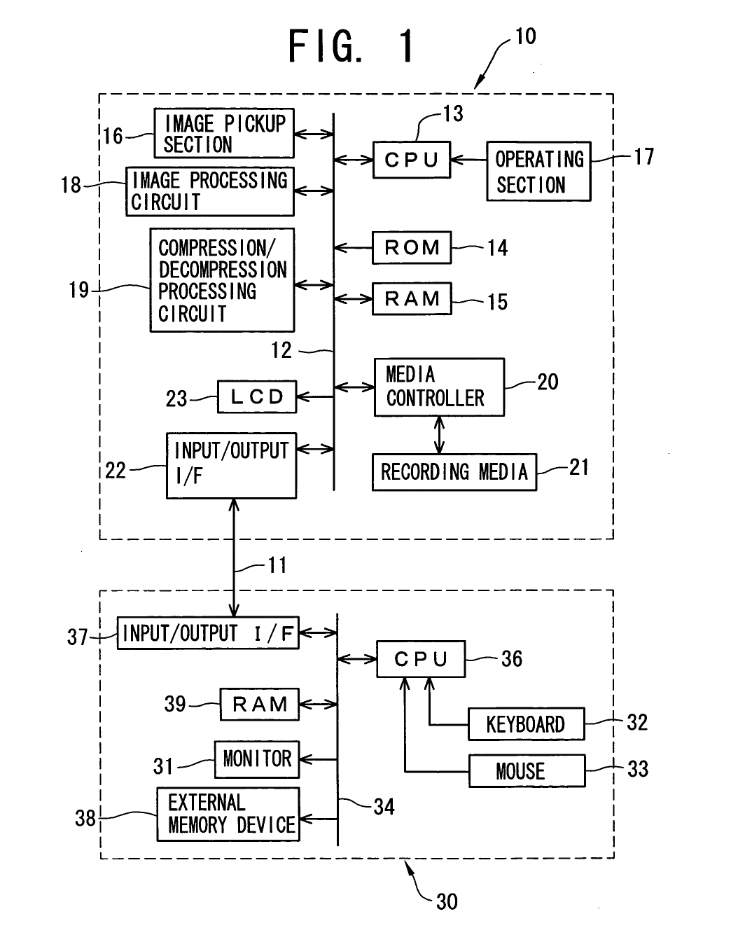

Commercially available personal computer, in which an image correction program is installed, is used for a personal computer (PC) 30 for image correction. As shown in FIG. 1, a digital camera 10 and the PC 30 for the image correction are connected via a communication cable 11 to transmit and receive camera control data and image data between the digital camera 10 and the PC 30 for the image correction. As for the communication cable 11, for instance, a USB (Universal Serial Bus)-compliant communication cable or an IEEE 1394-compliant communication cable can be used. Wireless communication means can also be used for exchanging data between the digital camera 10 and the PC 30 for the image correction instead of the communication cable 11.

Each section of the digital camera 10 is interconnected via a data bus 12, and a CPU 13 controls overall operations of the digital camera 10. A program for operating the digital camera 10 is recorded in ROM 14, and is loaded in RAM 15 when the digital camera 10 is turned on. An image pickup section 16 includes known taking lens, CCD and the like, and photoelectrically converts optical image of an object to digital image data. Camera settings, such as an aperture or a shutter speed, can be set by operating various set-up buttons provided in an operating section 17. It is also possible to determine the camera settings by the PC 30 for the image correction, and transmit camera setting data to the digital camera 10 via the communication cable 11. Further, it is also possible to connect an additional PC to the digital camera 10 for controlling shooting.

Image data, which is output from the image pickup section 16, is buffered in the RAM 15. The image data is initial image data (RAW data), which has not been subjected to image correction such as white-balance processing, and is constituted of a plurality of pixel data having gradation value of 12 bits per color. An image processing circuit 18 reduces the gradation value of the initial image data to 8 bits per color, and applies the white-balance processing and gradation conversion to the image data according to predetermined conditions, which depends on a digital camera model, and outputs corrected image data.

A compression/decompression processing circuit 19 compresses the corrected image data according to a JPEG (Joint Photographic Coding Expert Group) format, and outputs compressed image data. Further, the compression/decompression processing circuit 19 generates JPEG image data (thumbnail image data) of 1280×960 pixels, for instance, by thinning operations of the corrected image data.

The initial image data or the compressed image data is transmitted to the PC 30 for the image correction via an input and output I/F 22 along with the thumbnail image data. An LCD 23 continuously displays an object image in a shooting mode, and replays images stored in a recording media 21 in a reproduction mode.

Whether to output the initial image data or the compressed image data is determined concurrently with setting the camera settings of the digital camera 10. It is also possible to output both the initial image data and the compressed image data. The following describes an embodiment in which only the initial image data is output from the digital camera 10. In the embodiment, the initial image data is directly transmitted to the PC 30 for the image correction via the input and output I/F 22. However, it is also possible to transmit the initial image data to the PC 30 for the image correction by recording the initial image data in the recording media 21 and setting the recording media 21 in the PC 30 for the image correction.

The PC 30 for the image correction reproduces and displays the image on a monitor 31 according to the initial image data transmitted from the digital camera 10, and applies various image corrections in response to operation signals sent from input devices such as a keyboard 32 and a mouse 33. Each section of the PC 30 for the image correction is interconnected via a data bus 34, and CPU 36 controls overall operations of the PC 30 for the image correction. The image data transmitted from the digital camera 10 is recorded in an external memory device 38, such as a hard disk, via an input and output I/F 37 and the data bus 34. The input devices, such as the keyboard 32 and the mouse 33, are operated to set the camera settings of the digital camera 10, besides applying image correction processing, which will be described later.

The image correction program is installed in the external memory device 38 of the PC 30 for the image correction via memory media such as a CD-ROM, a DVD-ROM and the like, or the Internet. When the image correction program is executed by operating the keyboard 32 and the mouse 33, RAM 39 loads the image correction program. When the image correction program is executed, the thumbnail images, which correspond to the initial image data recorded in the external memory device 38, are displayed on the monitor 31 in a list form.

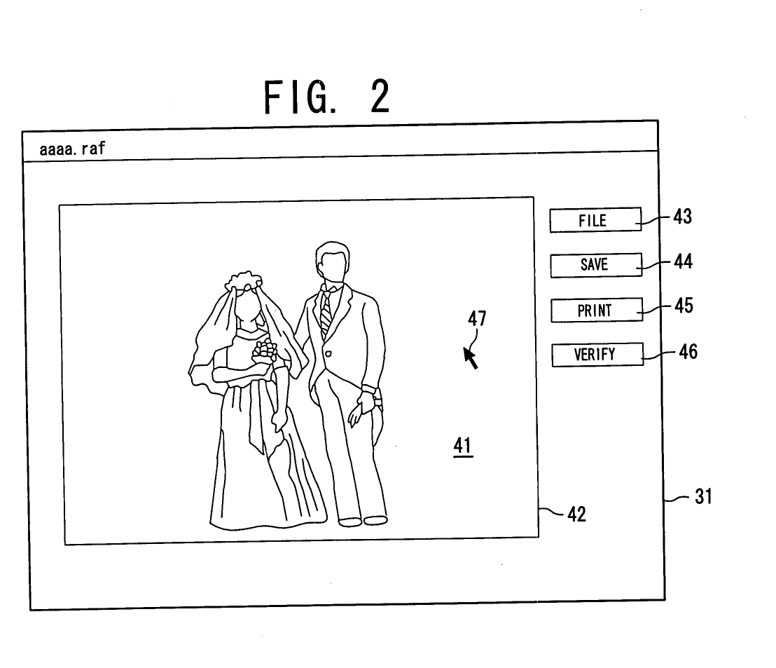

When the operator selects an image to be corrected by operating the keyboard 32 and the mouse 33, the initial image data, which corresponds to the selected image, is loaded in the RAM 39. Then, the initial image data is converted to display image data, for instance, with gradation value of 16 bits per color in Tiff (Tagged Image File Format) according to initial conditions predetermined by the image correction program. Thereby a first correction screen is displayed on the monitor 31 as shown in FIG. 2.

In FIG. 2, the first correction screen includes an image display area 42 and a workspace (not shown) for changing the correction parameters which are used for white balance correction, gradation correction, and the like. A selected image (a target image for the image correction) 41 is displayed in the image display area 42, and with the operation of the keyboard 32 or the click of the mouse 33, the correction parameters for the white balance correction and the gradation correction are changed. At that time, the initial image data, which corresponds to the selected image 41, is corrected by applying the changed correction parameters, and the display Image data is generated again. Thereby, an image, in which the changes in the parameters are reflected, is displayed in the image display area 42. Hereinafter, a process of correcting the initial image data and outputting the corrected data as the display image data is referred to as developing.

The monitor 31 displays buttons 43-46 to input various commands. The mouse 33 is operated to move a cursor 47 on a file button 43, and is clicked to display the thumbnail images, which correspond to the initial image data recorded in the external memory device 38, on the monitor 31 in a list form, so that the operator can select images to be corrected therefrom. With a click of a save button 44, the image displayed in the image display area 42 is output as a file. With a click of a print button 45, the image displayed in the image display area 42 is output as a print.

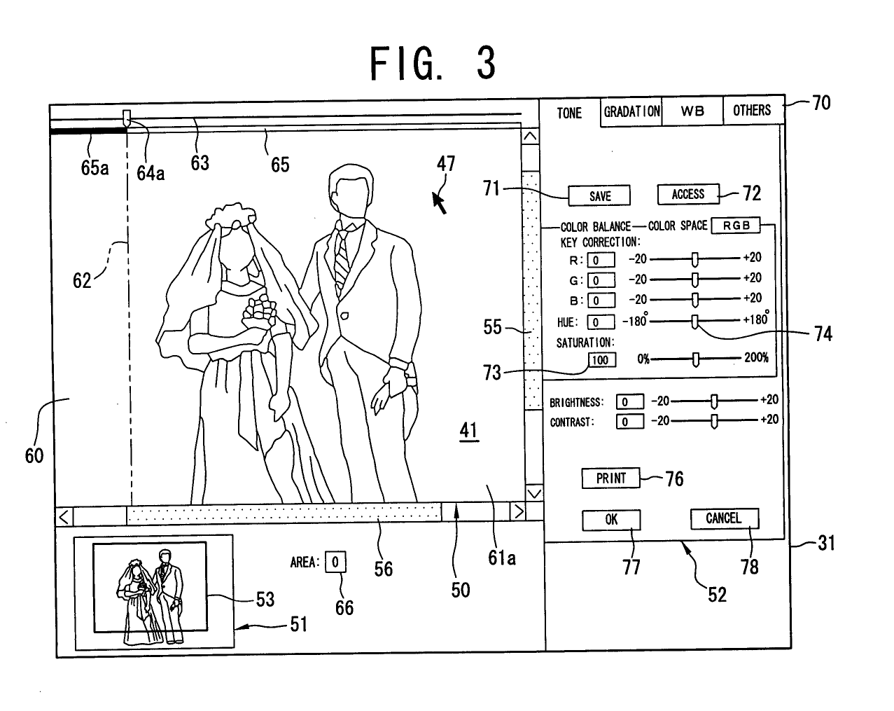

With a click of a verify button 46, the monitor is switched to a second correction screen in which the image display areas are divided for image verification. The second correction screen continuously displays images, which are corrected by using different parameters, in such a way that the corrected images are overlaid with one another. As shown in FIG. 3, the monitor 31 displays a main display section 50 for displaying the selected image 41, a sub display section 51 for displaying a reduced image of the selected image 41, and a parameter adjusting section 52.

In the sub display section 51, the whole selected image 41 is displayed in a reduced size. Further, a rectangular display box 53 is provided inside the sub display section 51, and an area within the display box 53 is displayed in the main display section 50. A display range of the selected image 41 in the main display section 50 can be changed by moving scroll bars 55 and 56 which are respectively provided on a right side and a lower side of the main display section 50.

The main display section 50 is divided into display areas (partial display areas) which are adjacent to each other. In each display area, the selected image 41, to which individual correction parameters are applied, is displayed. In an example shown in FIG. 3, the main display section 50 is divided into two adjacent partial display areas, a reference display area 60 and a first display area 61a, by a virtual line 62. The virtual line 62 is provided to explicitly show a boundary between the two display areas 60 and 61a for the sake of convenience, so that the virtual line 62 is not actually displayed on the monitor 31.

Each image displayed in the reference display area 60 and the first display area 61a has been subjected to developing by applying individual correction parameters which differ from each other. Therefore, each corresponding display image data is also different from each other. The reference display area 60 is provided on the extreme left side of the main display section 50, for instance, and corresponds to the selected image 41 displayed in the first correction screen. Pixel data, which corresponds to a section to be displayed in the reference display area 60, of the display image data of the selected image 41, is loaded, and a part of the selected image 41 is displayed in the reference display area 60. Further, pixel data, which corresponds a section to be displayed in the first display section 61a, of the display image data, which is obtained by developing the initial image data by using the correction parameters adjusted in the second correction screen, is loaded, and the corrected image is displayed in the first display area 61a. Therefore, a single image, which is constituted of images with different tones and different white balance across the virtual line 62, is displayed in the main display section 50.

In an upper portion of the main display section 50, a slide bar 63, a length of which corresponds to a width of the main display section 50, is displayed. An indicator 64a is displayed such that the indicator 64a is overlaid with the slide bar 63. The indicator 64a indicates a boundary between display areas 60 and 60a. The indicator 64a moves to the right and left sides by placing the cursor 47 on the indicator 64a and dragging the cursor 47 to the right and left sides. Thereby, the boundary between the display areas 60 and 61a, that is, a display range, can be changed.

In an example shown in FIG. 3, there are two display areas, 60 and 61a. However, it is possible to increase or decrease a number of the display areas by inputting commands by operating the keyboard 32 and the mouse 33. When the number of display areas is increased, new indicators are displayed on the slide bar 63, which enable to change the boundaries of the additional display areas.

An area size display bar 65 is displayed between the main display section 50 and the slide bar 63. The area size display bar 65 extends in parallel with the slide bar 63. A section 65a, which corresponds to a target display area for the image correction (for instance, the reference display area 60 in FIG. 3), is highlighted. Thereby, the operator can easily distinguish the target display area for the image correction. Further, a box 66, which displays a number of the target display area for the image correction, is provided in a lower portion of the main display section 50. The target display area for the image correction can be switched by changing the number in the box 66 by operating the keyboard 32. At that time, a position of the highlighted section 65a is also switched. It is also possible to switch the target display area for the image correction by placing the cursor 47 in the main display section 50 and operating the mouse 33 with predetermined operation, such as a double-click.

The parameter adjusting section 52 has four types of screens for adjusting the image, which are for color tone correction, gradation correction, white balance (WB) correction and other special processing respectively. By selecting a changeover tab 70, which is provided in an upper portion of the parameter adjusting section 52, the screen for adjusting the image is switched to the other type. As shown in FIG. 3, when a tab for the color tone correction is selected, the screen for the color tone correction is displayed in the parameter adjusting section 52, so that parameters for color balance, brightness and contrast, can be adjusted.

A save button 71 and an access button 72 are provided below the changeover tab 70. With a click of the save button 71, a correction condition file, which includes current correction parameters, is saved with an arbitrary file name. With a click of the access button 72, a list of the correction condition files, which have already been saved, is displayed. A correction condition file is selected from the list of correction condition files, and then the initial image data of the selected image 41 is developed according to the correction parameters included in the selected correction condition file, and displayed in the main display section 50. When the operator wishes to carry out the same image correction as the image correction, which has already been applied to another image, it is only necessary to make access to the correction condition file. Therefore, the image correction can be carried out easily.

In a center portion of the parameter adjusting section 52, respective values of correction parameters, such as color balance (for each color of red, green and blue, hue, and saturation), brightness, and contrast are displayed. It is possible to change each value of the correction parameters by directly inputting the value in an input box 73 of each item, or moving an indicator 74 to the right or left sides. When each correction parameter is changed, the initial image data, which corresponds to the selected image 41, is developed, and the corrected image is displayed in the main display section 50.

In a lower portion of the parameter adjusting section 52, a print button 76, an OK button 77 and a cancel button 78 are provided. With a click of the print button 76, an image displayed in the main display section 50 is output for printing. With a click of the OK button 77, the display is returned to the first correction display as shown in FIG. 2, and the image, which corresponds to the selected display area, is displayed. With a click of the cancel button 78, the image, which corresponds to the reference display area, is displayed in the first correction screen without reflecting the changes in the correction parameters.

When a tab for the gradation correction is selected, parameters for tone curve or gamma correction can be changed. Further, when a tab for the white balance correction is selected, a light source and a color temperature can be changed along with displaying a density histogram for each fundamental color. Further, when a tab for the special processing is selected, parameters for hyper-tone processing or hyper-sharpness processing can be adjusted.

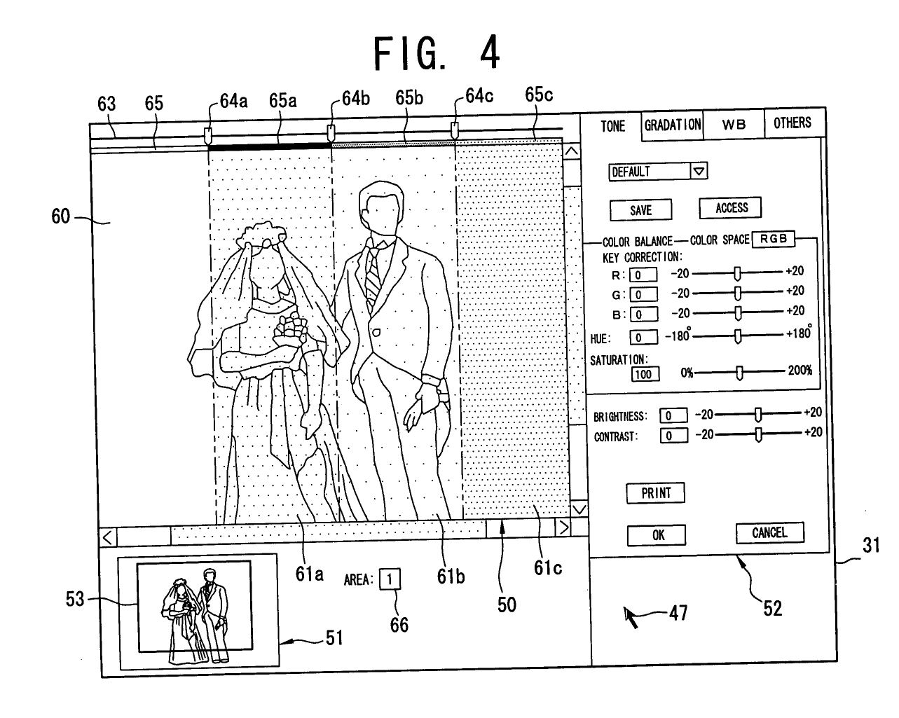

An example of the second correction screen is shown in FIG. 4. In the example, the reference display area 60 and the first to the third display areas 61a-61c are provided in the main display section 50. Correction parameters of each display area 60, 61a, 61b and 61c differ from each other, and each finished quality of the hue correction, the contrast correction and the white balance correction, of the displayed image also differ from each other. Further, there are three indicators 64a-64c on the slide bar 63. For instance, a width of the first display area 61a can be changed by sliding two indicators 64a and 64b which are located on the left side. The operator selects a target display area for the image correction (for instance, the first display area 61a), and changes the correction parameters. Then, the target image is developed according to the changed parameters, and a part of the developed image is displayed in the first display area 61a.

Thus, results of the image correction with different correction parameters are continuously displayed in a single display image. Therefore, even if differences in correction parameters are small, it is easy to visually identify changes in the corrected image. For instance, when the operator wishes to slightly change the hue of the right arm of a man in the image, the operator can slightly change the correction parameter values between the first display area 61a and the second display area 61b. Thereby, the images, which have been developed, are continuously displayed in the right arm section. Therefore, it is easy to visually identify differences in the image between before and after the image correction, so it becomes possible to correct the images efficiently.

Further, sections 65b and 65c of the area size display bar 65, which correspond to non-selected display areas (for instance, the second and the third display areas 61b and 61c), are displayed in different gray gradation or in different colors respectively. Therefore, it is easy for the operator to visually identify a boundary between non-selected display areas 61b and 61c.

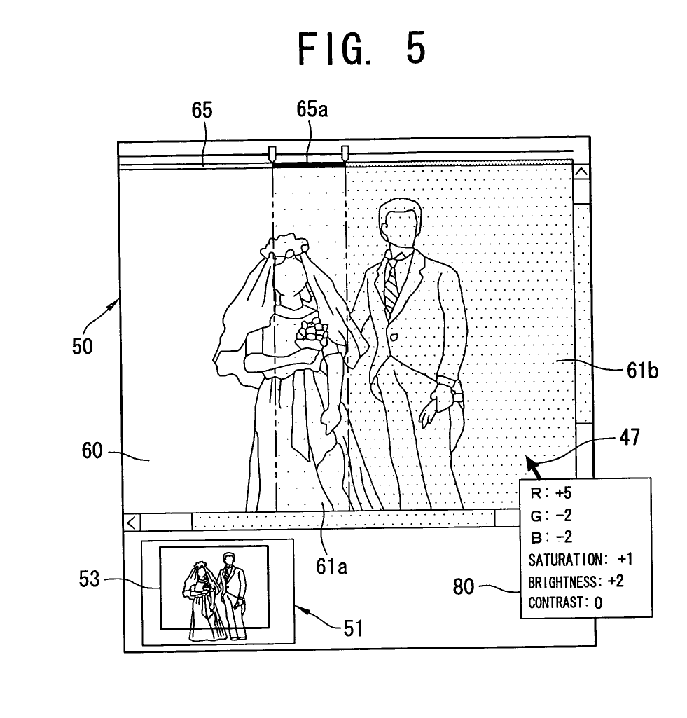

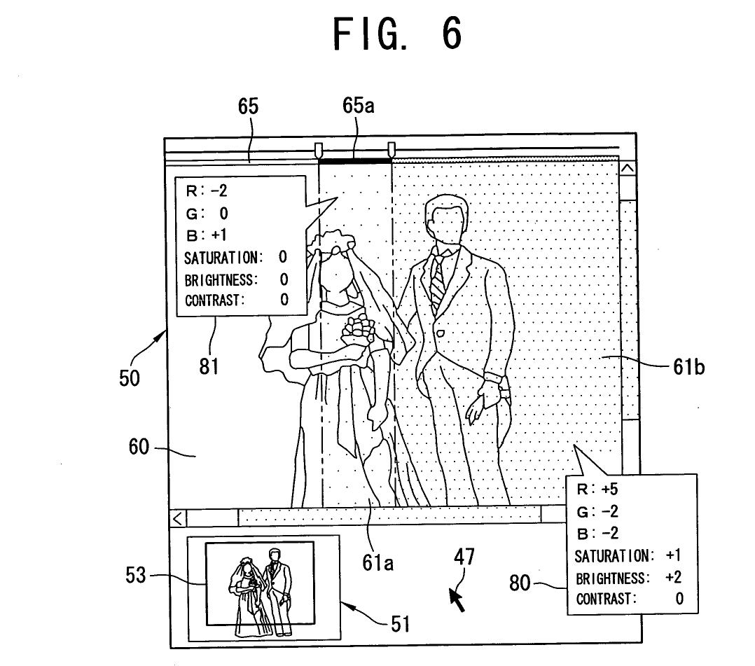

As shown FIG. 5, an information window 80 is displayed when a cursor 47 is paused for a predetermined period of time or when the mouse is clicked while the cursor 47 is in the second display area 61b. The information window 80 is placed adjacent to the cursor 47, and displays the correction parameter values in rows. Thus, the correction parameter values, which correspond to each display area, can be verified. Further, as shown in FIG. 6, it is possible to concurrently display information windows 80 and 81 which correspond to plural display areas. Furthermore, the correction parameter values, which correspond to the reference display area 60, can be displayed. The parameter adjusting section 52 is omitted in FIGS. 5-14 for the sake of simplification the drawings.

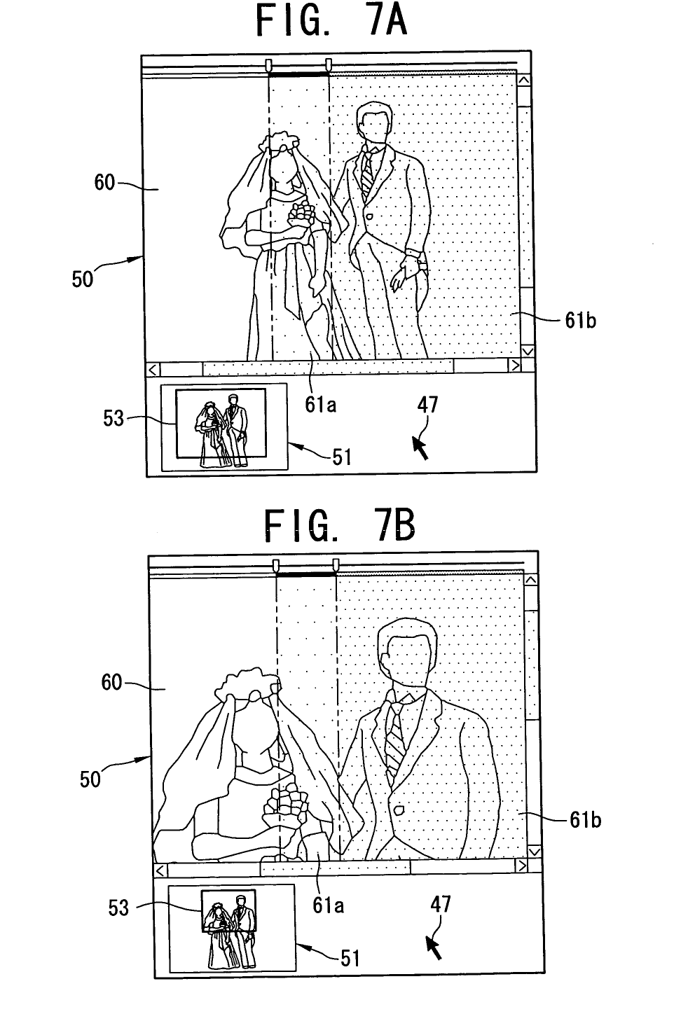

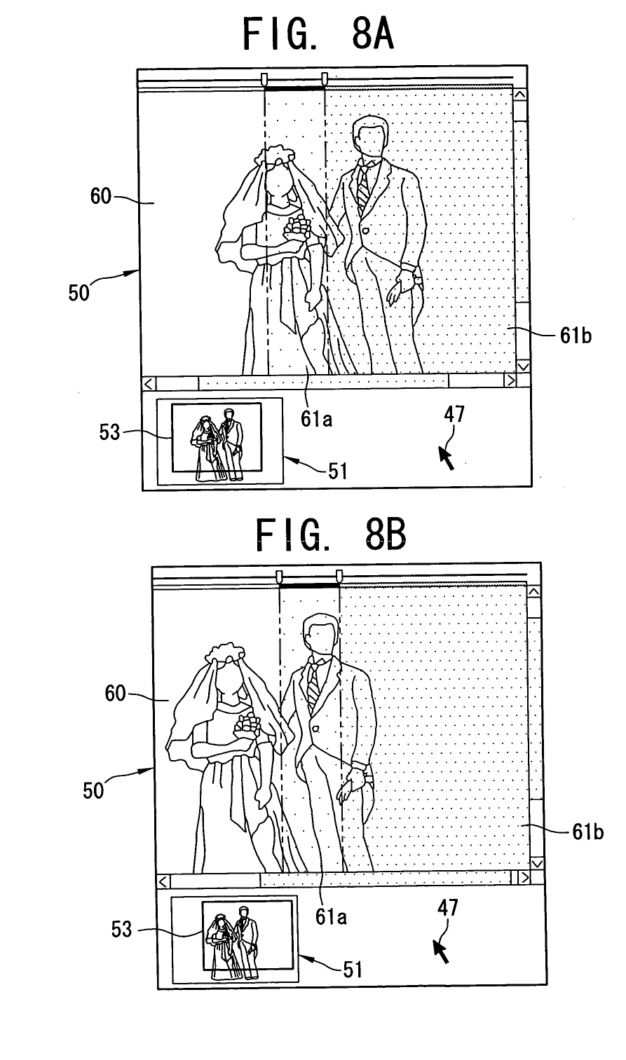

A position or a size of the image displayed in the main display section 50 can be changed by changing a position or a size of the display box 53 with the operation of the mouse 33. For instance, when the display box 53 shown in FIG. 8A is shifted to the right side, a display range of the image displayed in the main display section 50 is shifted to the left side (see FIG. 8B). Further, when the size of the display box 53 shown in FIG. 7A is reduced, the image displayed in the main display box 50 is enlarged (see FIG. 7B).

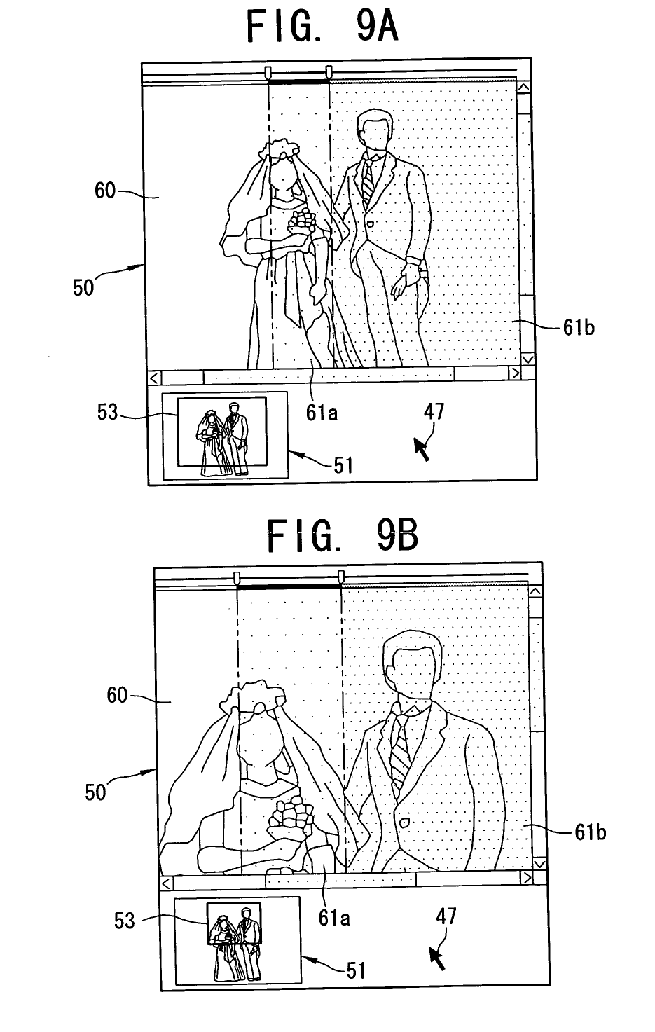

In examples shown in FIGS. 7 and 8, the position and the size of the image displayed in the main display section 50 are varied while proportion of the width of each display area 60, 61a and 61b, is remained constant. However, the proportion of the widths can be properly changed. For instance, as shown in FIGS. 9A and 9B, respective widths of the display areas 60, 61a and 61b can be changed while keeping positions of the boundaries between each of the display areas 60, 61a and 61b, constant with respect to the displayed image. Thus, the position and the size of the displayed image can be changed while maintaining the boundaries between each of the display area 60, 61a, and 61b.

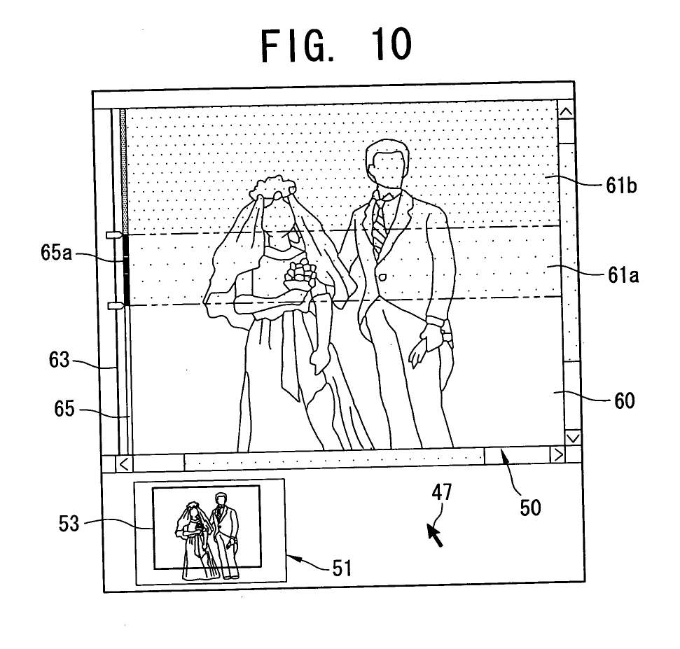

In the above embodiment, the slide bar 63 and the area size display bar 65 are provided in the upper portion of the main display section 50. However, it is possible to display the slide bar 63 and the area size display bar 65 in the lower portion of the main display section 50. Further, as shown in FIG. 10, the slide bar 63 and the area size display bar 65 can be displayed on the right side or the left side of the main display section 50.

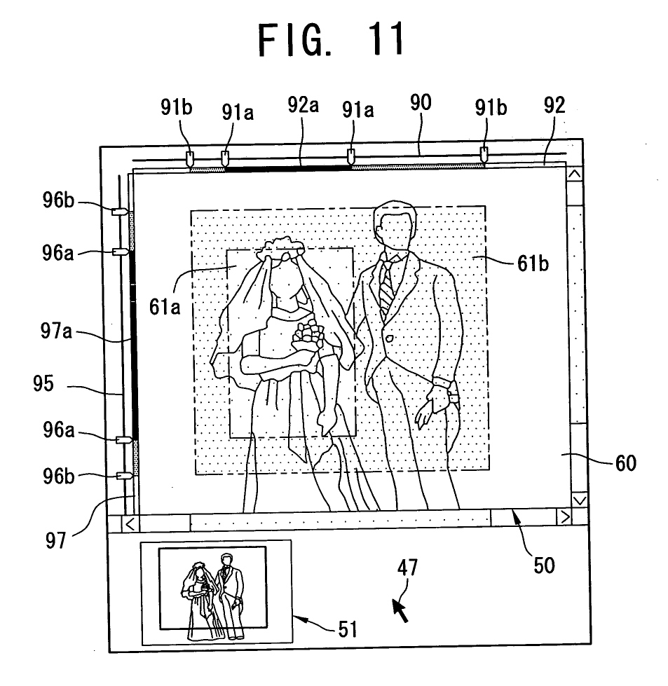

As shown in FIG. 11, it is also possible to display the slide bar 63 and the area size display bar 65 on the upper and the left sides of the main display section 50 respectively, and dispose each display area 60, 61a and 61b in a two-dimensional form. Each pair of indicators 91a and 91b is displayed on a slide bar 90 in an upper portion of the main display section 50. The pair of indicators 91a corresponds to the first display area 61a. The pair of indicators 91b corresponds to the second display area 61b. An area size display bar 92 is provided below the slide bar 90. Each section of the area size display bar 92, which corresponds to each display area 60, 61a and 61b, is displayed in gray color of different density. A section 92a, which corresponds to the selected display area (for instance, the first display area 61a in FIG. 11) is highlighted.

Each pair of indicators 96a and 96b is displayed on the slide bar 95 on the left side. The pair of indicators 96a corresponds to the first display area 61a. The pair of indicators 96b corresponds to the second display area 61b. On the right side of the slide bar 95, an area size display bar 97 is displayed. Each section of the area size display bar 97, which corresponds to the display areas 60, 61a and 61b respectively, is displayed in gray color of different density with respect to corresponding display area. A section 97a, which corresponds to the selected display area (for instance, the first display area 61a in FIG. 11), is highlighted.

In the example, the display areas 60, 61a, and 61b can be changed to the two-dimensional form by moving the indicators 91a, 91b, 96a and 96b. As with the above embodiment, the image of each display area is displayed in the same screen. Therefore, it is easy to visually identify differences in the images between before and after the correction, so that it becomes possible to correct the images efficiently. In an example shown in FIG. 11, the indicators 91a and 96a, which correspond to the first display area 61a, are located inside the indicators 91b and 96b which correspond to the second display area 61b. However, it is possible to move at least one of the indicators 91a and 96a outside the indicators 91b and 96b which correspond to the second image display area 61b.

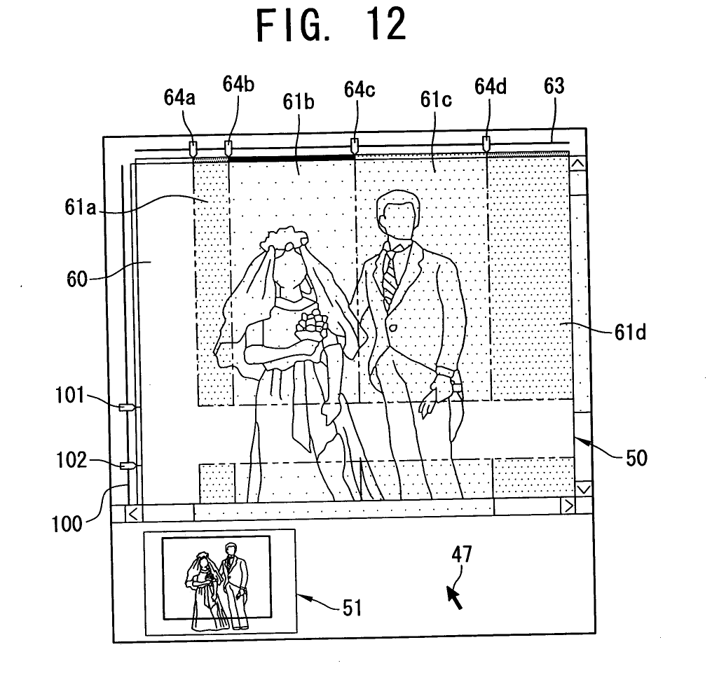

As shown in FIG. 12, the reference display area 60 can be formed in L-shape or T-shape. In that case, a width of the reference display area 60 in a vertical direction of the drawing can be changed by moving indicators 101 and 102, which are overlaid on a slide bar 100 on the left side, in the up-and-down directions. All images displayed in the first to the fourth display areas 61a-61d are adjacent to an image in the reference image area 60. Therefore, it is easy to visually identify differences in finished quality of each image with respect to the image in the reference image area 60.

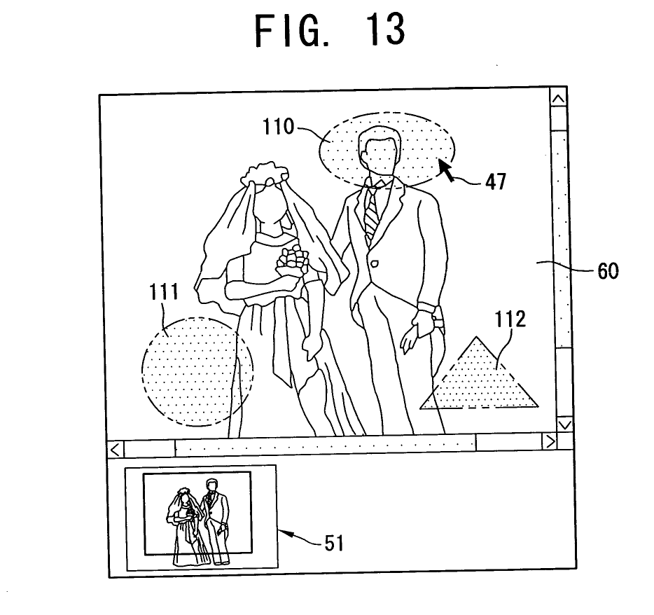

In the above embodiment, the main display section 50 is divided in rectangular display areas; however, it does not necessarily require a rectangular shape. For instance, as shown in FIG. 13, it is possible to provide a circular display area 110, an oval display area 111 or a triangular display area 112 in the main display area 50. Further, the display area can also take other shapes. It is also possible to enlarge or move each area 110-112 in the main display section 50. Chain double-dashed lines surrounding areas 110-112 are virtual lines, so that they are not actually displayed on the monitor 31.

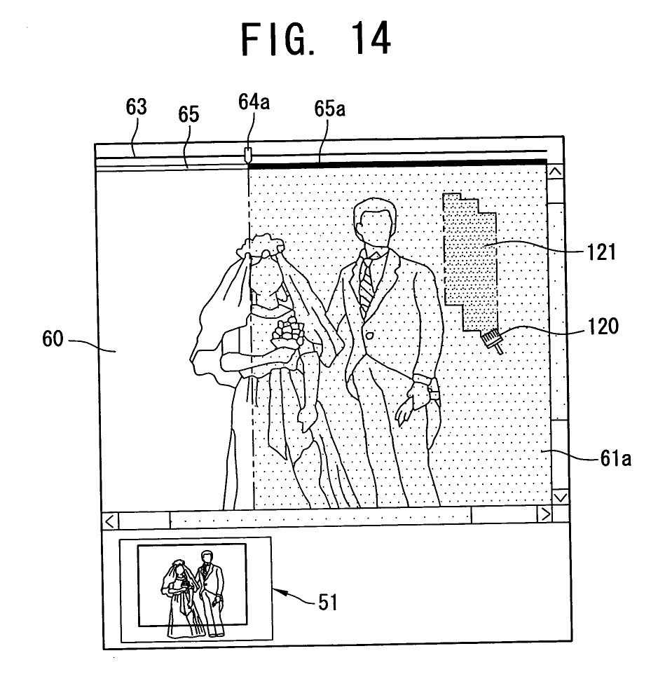

It is also possible to generate two corrected images (a first image and a second image) by applying two types of correction parameters for developing, and display an image which is obtained by compositing the above two corrected images in a predetermined proportion. As shown in FIG. 14, the first image is displayed in the first display area 61a. Then, a composite image of the image 1 and image 2, which are composited in a predetermined proportion, is displayed in a composite image display area 121 which is created by dragging a brush-shaped cursor 120. For instance, when a gradation value of the first image is defined as P1 and that of the second image is defined as P2 with respect to a pixel in the composite image display area 121, the corresponding pixel is displayed at a gradation value P3 which is defined as
P3=α•P1+(1−α)•P2.
Each time the cursor 120 is dragged, a value of the above parameter α is gradually decreased from 1, so that P3 approaches a value of the second image. Further, it is also possible to set the parameter α larger than 1, or at a negative number. The chain double-dashed lines surrounding the composite image display area 121 are the virtual lines, so that they are not actually displayed on the monitor 31.

In the above embodiment, the initial image data is corrected, converted to display data, and displayed on the monitor. However, the present invention can also be used in a case where the display data (in a bitmap format or the JPEG format) is corrected, reproduced, and displayed.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. An image correction method for correcting a target image for image correction while observing said target image displayed in an image display area on a monitor, said image correction method comprising the steps of:
(a) dividing said image display area into a plurality of partial display areas; and
(b) correcting a part of said target image displayed in each of said partial display areas by using individual correction parameters with respect to each of said partial display areas.

2. An image correction method as claimed in claim 1, wherein each of said partial display areas is changeable between a one-dimensional form and a two-dimensional form.

3. An image correction method as claimed in claim 2, wherein an indicator, which shows a boundary of said two adjacent partial display areas, is displayed in a surrounding area of said image display area, and said partial display area is changeable according to a movement of said indicator.

4. An image correction method as claimed in claim 2, wherein an area size display bar, which shows a display range of each of said partial display area, is displayed in a surrounding area of said image display area.

5. An image correction method as claimed in claim 4, wherein said area size display bar, which corresponds to a selected partial display area of said plurality of said partial display areas, is highlighted for inputting said correction parameters.

6. An image correction method as claimed in claim 5, wherein said area size display bar is displayed in a different color or in a different density to distinguish said display range among a plurality of non-selected partial display areas.

7. An image correction method as claimed in claim 2, wherein a position and a size of said target image displayed in said image display area are changeable while keeping each image display range in each of said image display areas at a constant proportion.

8. An image correction method as claimed in claim 2, wherein a position and a size of said target image displayed in said image display area are changeable while keeping a position of a boundary of said partial display areas constant with respect to said target image.

9. An image correction method as claimed in claim 2, wherein at least one information window, which displays values of said correction parameters corresponding to said partial display area, is displayed.

10. An image correction method as claimed in claim 2, wherein one of said plurality of said partial display areas is a reference display area for displaying said target image which is corrected by invariable correction parameters.

11. An image correction method as claimed in claim 10, wherein said reference display area lies adjacent to all of said remaining partial display areas.

12. An image correction method as claimed in claim 2, wherein at least one of said two target images, each of which is corrected by different correction parameters, is displayed in said partial display area, and a composite image is generated by compositing said two target images in a predetermined proportion, and a part of said partial display area is overwritten with said composite image.

13. An image correction method as claimed in claim 12, wherein a cursor for displaying said composite image is displayed on said monitor, and said composite image is displayed in an area through which said cursor passed.

14. An image correction method as claimed in claim 13, wherein said proportion increases or decreases every time said cursor passes through said area in which said composite image is displayed.

15. An image correction apparatus comprising:
a monitor having an image display area;
a dividing means for dividing said image display area into a plurality of partial display areas;
a correcting means for correcting a part of a target image for image correction, which is to be displayed in said partial display area, by correction parameters which are determined with respect to each of said partial display areas; and
a display control means for displaying said target image, which is separately corrected in each of said partial display areas, in said image display area.

16. An image correction apparatus as claimed in claim 15, said image correction apparatus further comprising a changing means for changing a position and a size of each of said partial display areas.

17. An image correction apparatus as claimed in claim 16, wherein said display control means displays an area size display bar, which shows a display range of said partial display area, on said monitor.

18. An image correction program for activating a computer, said image correction program comprising:
a division function for dividing a display area on a monitor into a plurality of partial display areas;
a correction function for correcting a part of a target image for image correction, which is to be displayed in said partial display area, by correction parameters which are determined with respect to each of said partial display area; and
a display function for displaying said target image, which is separately corrected in each of said partial display area, in said image display area.
